(19) United States
(12) Patent Application Publication
(10) Pub. No.: US 2015/0284106 A1
(43) Pub. Date: Oct. 8, 2015

(54) AERIAL REFUELING BOOM WITH PRESSURE LIMITING VALVE

(71) Applicant: EATON CORPORATION, Cleveland, OH (US)

(72) Inventor: James William Reinholdt, San Clemente, CA (US)

(21) Appl. No.: 14/632,038

(22) Filed: Feb. 26, 2015

Related U.S. Application Data
(60) Provisional application No. 61/946,455, filed on Feb. 28, 2014.

(51) Int. Cl. B64D 39/04; B64D 39/06

(52) U.S. Cl. CPC B64D 39/04; B64D 39/06

(57) ABSTRACT

A refueling boom is provided for use in an aerial refueling system. The refueling boom may include a boom section configured to extend from a tanker aircraft. A pressure limiting valve may be provided downstream of the boom section. A boom nozzle may be provided downstream of, or integral with, the pressure limiting valve.

### CROSS-REFERENCE TO RELATED APPLICATION

This application claims the benefit of U.S. Provisional Application Ser. No. 61/946,455, filed Feb. 28, 2014 the disclosure of which is incorporated herein by reference in its entirety.

### TECHNICAL FIELD

The present disclosure relates to refueling booms that can be used in aerial refueling systems for aircraft, including a refueling boom with a pressure limiting valve that may be located in close proximity to the boom nozzle.

### BACKGROUND

Aerial refueling systems can be used to transfer a supply of fuel from a tanker aircraft to a receiver aircraft during flight. For example, one type of aerial refueling system is commonly referred to as a flying boom system. In a flying boom system, the tanker aircraft may include a telescoping boom that extends from the rear of the aircraft. The boom may include a generally rigid boom section having movable flight control surfaces (i.e., airfoils), which can enable an operator to selectively control movement and positioning of the boom relative to the tanker aircraft during flight. A nozzle can be provided at a distal end of the boom and may be attached to the boom section, for example, by a threaded flange.

On the receiver aircraft, a receptacle may be provided for receiving the nozzle. During a refueling operation, the nozzle may be inserted into the receptacle to form a fluid connection with the receptacle. Once a fluid connection is formed between the nozzle and the receptacle, a supply of fuel can be delivered from the tanker aircraft to the receiver aircraft.

To regulate the flow rate and fluid pressure of the fuel being delivered from the tanker aircraft to the receiver aircraft, aerial refueling systems may include pressure regulating devices. For example, a flying boom aerial refueling system may include a primary pressure regulator, which is generally located in the fuselage of the tanker aircraft. The primary pressure regulator can limit the fluid pressure at the inlet of the boom nozzle to a maximum pressure, such as approximately 55 PSIG, so as to prevent over-pressurization of the receiver aircraft's aerial refueling system. However, because the pressure is controlled to approximately 55 PSIG at the inlet of the boom nozzle respective of fuel flow rates, at high fuel flow rates, in the 1200 GPM range for example, the pressure at the outlet of the receiver aircraft's receptacle could be in the range of approximately 30 PSIG instead of the approximately 55 PSIG range that it is designed for. Thus, limiting the pressure at the inlet of the boom nozzle to approximately 55 PSIG at high fuel flow rates may limit the tanker aircraft's offload rate.

### SUMMARY

According to an embodiment of the present disclosure, an aerial refueling boom may include a pressure limiting valve that can be provided in a location other than or in addition to a fuselage of a tanker aircraft. Among other features, the refueling boom of the present disclosure may allow a tanker aircraft to offload fuel at higher rates without risking over pressurization of a receiver aircraft. The refueling boom may also allow higher fluid pressures at the inlet of a boom nozzle to compensate for the pressure drop across the boom nozzle and receptacle at relatively high fuel flow rates.

In an embodiment, for example, a refueling boom of the present disclosure may include a boom section configured to extend from a tanker aircraft. A pressure limiting valve may be provided downstream of the boom section. A boom nozzle may be provided downstream of, or integral with, the pressure limiting valve.

In another embodiment, an aerial refueling system is provided for aircraft. The aerial refueling system may include a tanker aircraft having a supply of fuel. A refueling boom may be connected or attached to the tanker aircraft and may be in fluid communication with the supply of fuel. The refueling boom may comprise a boom section that can be connected or attached to a fuselage of the tanker aircraft and in fluid communication with the supply of fuel. A pressure limiting valve may be provided downstream of and in fluid communication with the boom section. A boom nozzle may be provided downstream of, or integral with, and in fluid communication with the pressure limiting valve.

Various aspects of the present disclosure will become apparent to those skilled in the art from the following detailed description of the various embodiments, when read in light of the accompanying drawings.

### BRIEF DESCRIPTION OF THE DRAWINGS

Embodiments of the present disclosure will now be described, by way of example, with reference to the accompanying drawings.

FIG. 1 is a perspective view of an aerial refueling system having a refueling boom according to an embodiment of the present disclosure.

FIG. 2 is an enlarged side view of a distal end of the refueling boom, as generally indicated by the broken circle in FIG. 1, according to an embodiment of the present disclosure.

FIG. 3 is an enlarged side view of a distal end of the refueling boom, as generally indicated by the broken circle in FIG. 1, according to another embodiment of the present disclosure.

FIG. 4 is a cross-sectional side view of a pressure limiting valve provided on the refueling boom generally shown in FIGS. 2 and 3, wherein the pressure limiting valve is generally shown in an opened position.

FIG. 5 is a cross-sectional side view of the pressure limiting valve generally shown in FIG. 4, wherein the pressure limiting valve is generally shown in a closed position.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

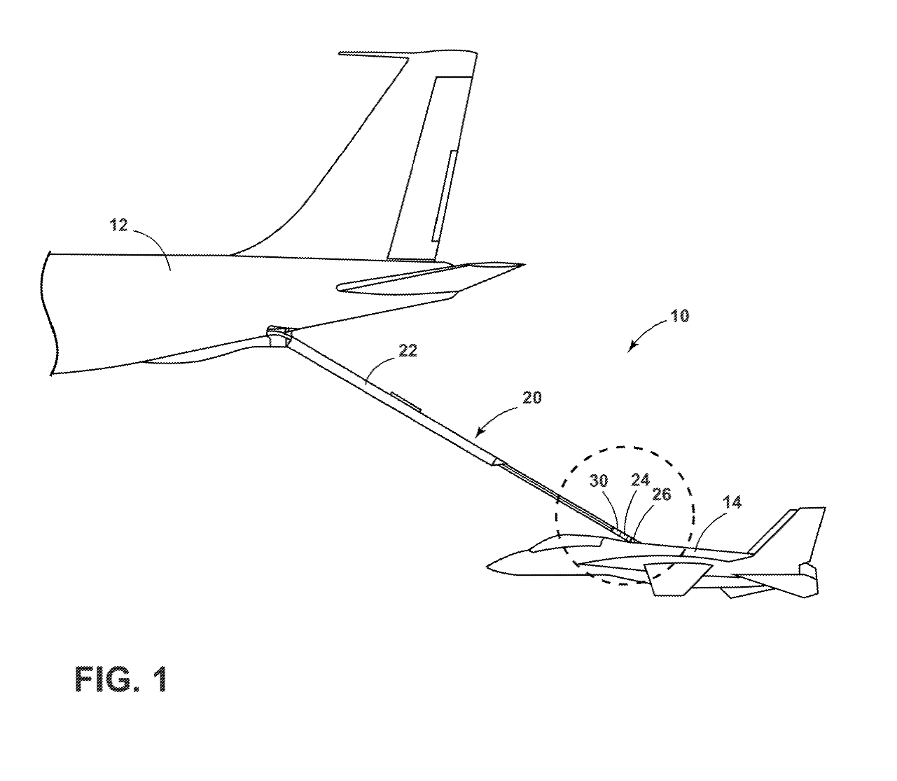

Referring now to FIG. 1, an aerial refueling system according to an embodiment of the present disclosure is shown, indicated generally at 10. In a non-limiting embodiment, the aerial refueling system 10 may be located at or near the rear of a tanker aircraft 12 and can be configured to connect with a receiver aircraft 14. As generally shown, the aerial refueling system 10 may include a refueling boom 20 that can extend from the tanker aircraft 12. The refueling boom 20 may generally include, but is not limited to, a boom section 22, an indexing unit 24, and a boom nozzle 26, although such are not required. The boom section 22 may be attached to or otherwise provided on a fuselage of the tanker aircraft 12, for example, by an articulating joint or other suitable connection. The boom section 22 may include movable flight control surfaces (e.g., airfoils), which can enable an operator to selectively control positioning of the refueling boom 20 relative to the receiver aircraft 14 during flight.

An indexing unit 24 may optionally be provided downstream of the boom section 22. For example, in a non-limiting embodiment, the indexing unit 24 may be connected or otherwise attached to a distal end of the boom section 22, either directly or indirectly. The indexing unit 24 can have an adjustable length and may be configured to facilitate and maintain a connection between the refueling boom 20 and the receiver aircraft 14. In operation, for example, when the refueling boom 20 is connected to the receiver aircraft 14, the indexing unit 24 may absorb forces or otherwise compensate for relative movement between the tanker aircraft 12 and the receiver aircraft 14 during flight.

A boom nozzle 26 may be provided downstream of the indexing unit 24 and may generally form a distal end of the refueling boom 20. In a non-limiting embodiment, the boom nozzle 26 may be connected or otherwise attached to a distal end of the indexing unit 24, either directly or indirectly. For example, the boom nozzle 26 may be connected to the indexing unit 24 or other component by a threaded flange or other suitable joint or connection.

In operation, for example, an end portion of the boom nozzle 26 can be configured for insertion into a receptacle, which may be provided on the receiver aircraft 14, so as to form a fluid-tight connection with the refueling system of the receiver aircraft 14. An internal fuel tube or other delivery device may extend through the refueling boom 20 and can be configured to provide a supply of fuel from the fuselage of the tanker aircraft 12 to the boom nozzle 26. Thus, after an acceptable connection (e.g., a fluid-tight connection) is formed between the boom nozzle 26 and the receptacle on the receiver aircraft 14, a supply of fuel can be delivered through the refueling boom 20 to the receiver aircraft 14.

Although the refueling boom 20 is described as generally including a boom section 22, an indexing unit 24, a boom nozzle 26, and an internal fuel tube, it should be appreciated that the refueling boom 20 is not limited to these components but may generally include other suitable components or configurations of components as desired.

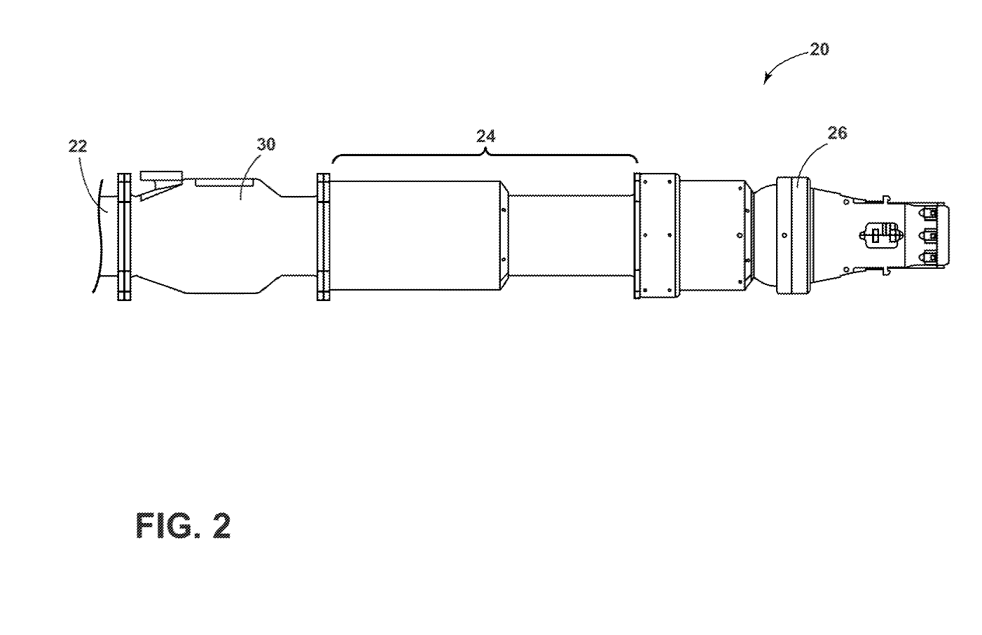

Referring now to FIG. 2, the refueling boom 20 may include a pressure limiting device, such as a pressure limiting valve, which can be configured to limit or otherwise control fluid pressure at or near the inlet of the boom nozzle 26. For example and without limitation, a pressure limiting valve 30 may be located in relatively close proximity to the boom nozzle 26. As a result, any fluid pressure gains that may be desirable at the inlet of the boom nozzle 26 under high fuel flow rate conditions can be included or otherwise accounted for by a pressure limiting device or valve. Thus, for example, a pressure limiting valve 30 may effectively limit the maximum amount of fuel pressure that is being delivered directly to the receiver aircraft 14. Moreover, if a primary pressure regulating device provided in the aerial refueling system 10 should fail, the pressure limiting valve 30 can provide added surge protection and over-pressurization protection of the refueling system on the receiver aircraft 14.

In a non-limiting embodiment, the pressure limiting valve 30 may be located downstream of the boom section 22. For example, as generally shown in FIG. 2, the pressure limiting valve 30 can be attached to an end of the boom section 22. In turn, the indexing unit 24 and the boom nozzle 26 can be attached to an opposite end of the pressure limiting valve 30. As such, the pressure limiting valve 30 may be located in close proximity to the boom nozzle 26.

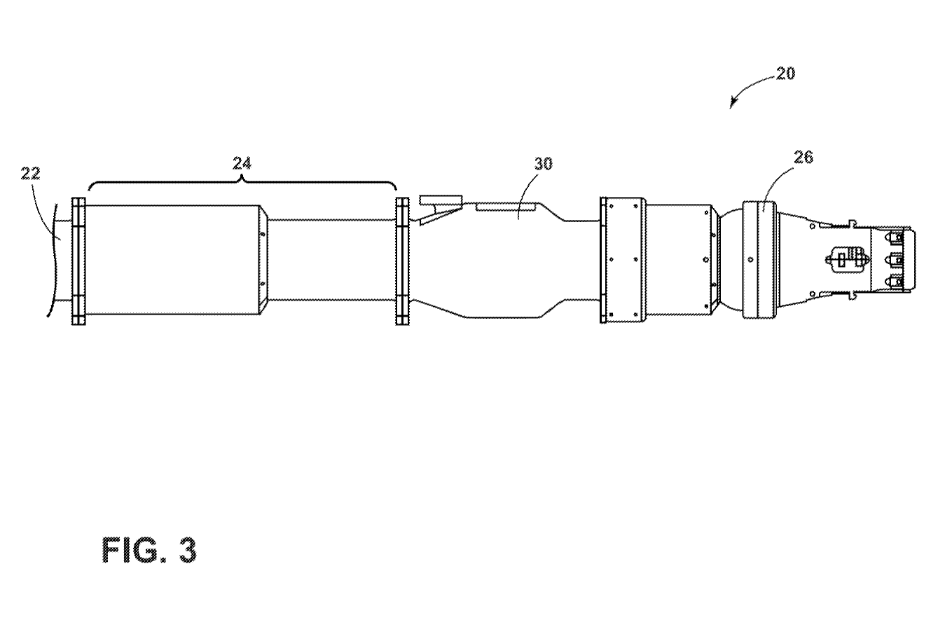

In another embodiment, a pressure limiting device or valve, such as pressure limiting valve 30, may be located downstream of the indexing unit 24. For example, as generally shown in FIG. 3, a pressure limiting valve 30 can be connected or attached to an end of the indexing unit 24. In turn, the boom nozzle 26 can be attached to an opposite end of the pressure limiting valve 30. As such, the pressure limiting valve 30 may be located in close proximity to the boom nozzle 26, which in this example is immediately upstream and directly adjacent to the boom nozzle 26.

In yet another embodiment, the pressure limiting valve 30 may be integrated into or with the boom nozzle 26. For example, the boom nozzle 26 and the pressure limiting valve 30 may be formed as a single or discrete unit or assembly. As such, a pressure limiting valve 30 may be located in close proximity to the boom nozzle 26. In this example, a pressure limiting valve 30 may be configured to directly limit or otherwise control the inlet pressure of the boom nozzle 26.

Thus, it should be appreciated that the location of the pressure limiting valve 30 along the refueling boom 20 is not limited to the embodiments described in the present disclosure. Rather, the pressure limiting valve 30 can be provided in various suitable locations along the refueling boom 20 that may be in relatively close proximity to the boom nozzle 26.

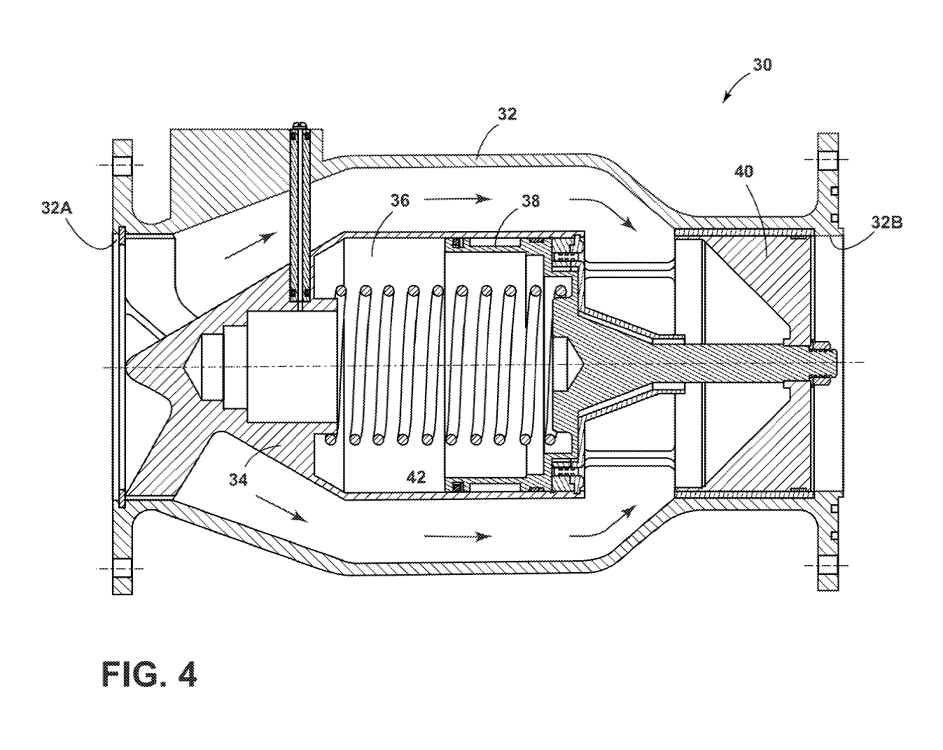

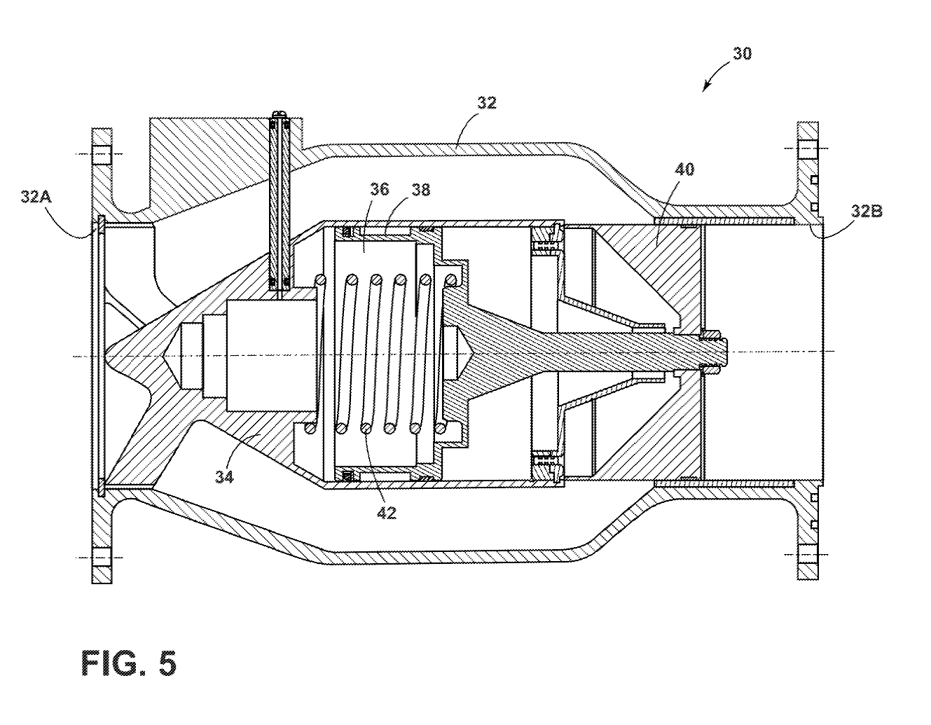

Referring now to FIGS. 4 and 5, a non-limiting example of a pressure limiting valve 30 is provided according to an embodiment of the present disclosure. As generally shown, the pressure limiting valve 30 may include an external housing 32 having an inlet opening 32A and an outlet opening 32B. The external housing 32 may also include end flanges that can be located near the inlet and outlet openings 32A, 32B and may be configured for attaching the pressure limiting valve 30 to components associated with the refueling boom 20.

As generally shown in the illustrated embodiment, a pressure limiting valve 30 may also include an internal valve housing 34 that can be disposed within the external housing 32 and, if desired, entirely within the housing 32. Thus, a flow path may be defined between an inner surface of the external housing 32 and an outer surface of the internal valve housing 34 to allow fuel and other liquids or gases to flow through the pressure limiting valve 30. In some embodiments, the flow path may be designed to reduce a pressure drop between the inlet opening 32A and the outlet opening 32B of the external housing 32. As such, the inlet pressure of the pressure limiting valve 30 can be significantly reduced while at the same time increasing the flow rate and maintaining a desired outlet pressure of the pressure limiting valve 30.

The internal valve housing 34 may include or define a piston chamber 36 having an open end that can open in a direction towards the outlet opening 32B of the external housing 32. The piston chamber 36 may be vented to the atmosphere for various purposes including those mentioned further below. A piston 38 may be configured and/or supported for axial movement within the piston chamber 36. A valve member 40 can be connected or attached to the piston 38 and configured for axial movement therewith. In a non-limiting embodiment, such as generally shown in FIGS. 4 and 5, a valve member 40 may comprise a sleeve or other suitable member that can be configured to close or otherwise restrict or obstruct the flow path through the pressure limiting valve 30. As discussed below, movement of the piston 38 may move the valve member 40 between an opened position, as generally shown in FIG. 4, and a closed or partially closed position, as generally shown in FIG. 5, so as to limit or otherwise control the outlet pressure of the pressure limiting valve 30.

In a non-limiting embodiment, at least one valve spring 42 or other resilient mechanism may be disposed within the piston chamber 36 to provide a biasing force between the piston 38 and an end of the piston chamber 36. As such, a valve spring 42 may be configured to bias the piston 38 and the valve member 40 in an opened position, for example, as will be described further below. It should be appreciated that a valve spring 42 can be configured to provide a spring load and spring rate to limit or otherwise control a maximum outlet pressure of the pressure limiting valve 30.

Operation of a pressure limiting device or valve in accordance with an embodiment of the present disclosure will now be further described. As generally illustrated in FIG. 4, a pressure limiting valve 30 may be in an opened position/setting during normal refueling conditions. In such a position/setting, fuel may generally flow unrestrained through the pressure limiting valve 30.

However, if or when the fuel pressure in the flow path increases beyond a select or predetermined threshold, a pressure limiting valve 30 may be configured to automatically restrict/obstruct or completely stop fuel flow through the valve. For example, if the fuel pressure in the flow path exceeds the biasing force of the valve spring 42 and atmospheric air pressure in the piston chamber 36, then the force generated by the fuel pressure may axially move the piston 38 within the piston chamber 36. Axial movement of the piston 38 in turn may move the valve member 40 relative to the flow path, initially to a partially closed position/setting and then to a fully closed position/setting, as generally shown in FIG. 5.

In a non-limiting example, a pressure limiting valve 30 may be configured to remain fully open until the fuel pressure at the outlet of the valve, for instance, approaches or exceeds approximately 55 PSIG. In another example, however, a pressure limiting valve 30 may be configured to begin closing when the fuel pressure at the inlet of the boom nozzle 26 approaches or exceeds approximately 80 PSIG. The pressure limiting valve 30 may also be configured to fully close when the fuel pressure in the flow path approaches or exceeds approximately 120 PSIG. In other embodiments, the pressure limiting valve 30 may be configured to partially or fully close when the fuel pressure in the flow path approaches, meets, or exceeds other suitable pressures and/or ranges of pressures.

It should be appreciated that the aerial refueling system 10, and more specifically the pressure limiting valve 30 located in the refueling boom 20, of the present disclosure may provide advantages over conventional aerial refueling systems. For example, the pressure limiting valve 30 located in the refueling boom 20 can be configured to limit or otherwise control a maximum amount of fuel pressure at or near the inlet of the boom nozzle 26. For example, a pressure limiting device or valve may allow pressures at the inlet of the boom nozzle 26 up to 80 PSIG before the device or valve begins operating to effectively limit the maximum amount of fuel pressure that is being delivered directly to the receiver aircraft 14 from exceeding, for example, 120 PSIG. In another example, a pressure limiting valve 30 located or disposed in a refueling boom 20 can provide additional or redundant surge protection and over-pressurization protection of the refueling system on the receiver aircraft 14. With such an example, if a primary pressure regulating device provided in the aerial refueling system 10 should fail, then a pressure limiting valve 30 located or disposed in the refueling boom 20 may be configured to automatically close if the fuel pressure approaches or exceeds a predetermined threshold. As a result, a refueling boom 20 could allow a tanker aircraft 12 to offload fuel at higher rates without risking over-pressurization of a receiver aircraft 14. It may also allow higher pressures at the inlet of the boom nozzle 26 to compensate for a pressure drop across the boom nozzle 26 and receptacle at high fuel flow rates. In addition, an aerial refueling system 10 and a refueling boom 20 may provide further advantages, which are not disclosed herein.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A refueling boom for use in an aerial refueling system, the refueling boom comprising:
a boom section configured to extend from a tanker aircraft;
a pressure limiting valve provided downstream of the boom section; and
a boom nozzle provided downstream of, or integral with, the pressure limiting valve.

2. The refueling boom of claim 1, wherein the pressure limiting valve is attached to a distal end of the boom section.

3. The refueling boom of claim 2, further including an indexing unit provided downstream of the pressure limiting valve.

4. The refueling boom of claim 3, wherein the indexing unit is attached to a distal end of the pressure limiting valve, and the boom nozzle is attached to a distal end of the indexing unit.

5. The refueling boom of claim 1, further including an indexing unit provided downstream of the boom section, and the pressure limiting valve is provided downstream of the indexing unit.

6. The refueling boom of claim 5, wherein the indexing unit is attached to a distal end of the boom section, and the pressure limiting valve is attached to a distal end of the indexing unit.

7. The refueling boom of claim 6, wherein the boom nozzle is attached to a distal end of the pressure limiting valve.

8. The refueling boom of claim 1, wherein the boom nozzle is attached directly to a distal end of the pressure limiting valve.

9. The refueling boom of claim 1, wherein the boom nozzle and the pressure limiting valve are integrated together as a single component.

10. The refueling boom of claim 1, wherein the pressure limiting valve includes a valve member that is automatically movable between an opened position and a closed position in response to fluid pressure within the pressure limiting valve.

11. The refueling boom of claim 10, wherein the valve member automatically moves from the opened position toward the closed position when fluid pressure within the pressure limiting valve reaches a predetermined pressure.

12. An aerial refueling system comprising:
a tanker aircraft having a fuselage and a supply of fuel;
a refueling boom connected or attached to the tanker aircraft and in fluid communication with the supply of fuel, wherein the refueling boom comprises:
a boom section connected or attached to the fuselage of the tanker aircraft and in fluid communication with the supply of fuel;
a pressure limiting valve provided downstream of and in fluid communication with the boom section; and
a boom nozzle provided downstream of, or integral with, and in fluid communication with the pressure limiting valve.

13. The aerial refueling system of claim 12, wherein the pressure limiting valve is attached to a distal end of the boom section.

14. The aerial refueling system of claim 13, further including an indexing unit provided downstream of the pressure limiting valve.

15. The aerial refueling system of claim 14, wherein the indexing unit is attached to a distal end of the pressure limiting valve, and the boom nozzle is attached to a distal end of the indexing unit.

16. The aerial refueling system of claim 12, further including an indexing unit provided downstream of the boom section, and the pressure limiting valve is provided downstream of the indexing unit.

17. The aerial refueling system of claim 16, wherein the indexing unit is attached to a distal end of the boom section, and the pressure limiting valve is attached to a distal end of the indexing unit.

18. The aerial refueling system of claim 17, wherein the boom nozzle is attached to a distal end of the pressure limiting valve.

19. The aerial refueling system of claim 12, wherein the pressure limiting valve includes a valve member that is automatically movable between an opened position and a closed position in response to fluid pressure within the pressure limiting valve.

20. The refueling boom of claim 19, wherein the valve member automatically moves from the opened position toward the closed position when fluid pressure within the pressure limiting valve reaches a predetermined pressure.
